(19) United States
(12) Patent Application Publication
(10) Pub. No.: US 2004/0032124 A1
(43) Pub. Date: Feb. 19, 2004

(54) Fitting for textile reinforced hose

(76) Inventors: Robert M. Lefere, Jackson, MI (US); Brian A. Mack, Jackson, MI (US); Terry L. Karl, Adrian, MI (US); John P. Brittain, Mason, MI (US); Bruce L. Curl, Jackson, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/219,866

(22) Filed: Aug. 15, 2002

(51) Int. Cl. F16L 33/00; F16L 47/00; F16L 49/00

(52) U.S. Cl. 285/242

(57) ABSTRACT

A hose fitting suitable for use with a reinforced hose is provided that includes a longitudinally extending body having a hose end and a coupling end. The body includes an exterior surface and an interior opening. The exterior surface of body defines a gripping surface and a reinforcement trapping surface. Fitting also includes a socket surrounding the body. The socket defines an interior surface, which cooperates with the exterior surface of the body to define a generally cylindrical opening for receiving the hose. The interior surface of the socket is positioned radially outward of the gripping surface and the reinforcement trapping surface. The hose reinforcement is trapped between the interior surface and the reinforcement trapping surface to inhibit movement of the hose reinforcement.

### BACKGROUND OF THE INVENTION

1. Field of the Invention

The present invention relates generally to a hose fitting and more particularly to a hose fitting for a textile reinforced hose.

2. Description of the Related Art

Textile reinforced hoses for conveying fluids typically include a polymeric inner tube and at least one braided or spiral wound reinforcement layer. These hoses are used in the manufacture of hose assemblies, which include a finite length of hose with a fitting attached to each end.

In so called two-layer hoses that include a textile reinforcement layer applied over an inner tube, the reinforcement layer is generally affixed to the inner tube to inhibit undesirable axial movement therebetween. Limiting axial movement between the reinforcement layer and the inner tube improves the fitting retention characteristics of a hose assembly, particularly when conveying a high pressure fluid.

In two-layer hoses that include a polymeric fluorocarbon inner layer and a para-aramid reinforcement layer, the para-aramid reinforcement layer is typically not affixed to the inner tube due the general difficulty in bonding the fluorocarbon inner tube to the para-aramid reinforcement. The inability to prevent movement between the para-aramid reinforcement and the fluorocarbon inner tube compromises the sealing performance of the hose assembly at the hose fitting interface, particularly at relatively high pressures, resulting in a loss of sealing engagement between the hose and fitting.

### SUMMARY OF THE INVENTION

A hose fitting is provided that is suitable for use with a hose having an inner tube and a reinforcing layer. The hose fitting includes a longitudinally extending body having a hose end and a coupling end. The body includes an exterior surface and an interior opening. The exterior surface of body defines a gripping surface and a reinforcement trapping surface. The fitting also includes a socket surrounding the body. The socket defines an interior surface, which cooperates with the exterior surface of the body to define a generally cylindrical opening for receiving the hose. The interior surface of the socket is positioned radially outward of the gripping surface and the reinforcement trapping surface.

During assembly, a portion of the hose inner tube is first removed or “skived,” the fitting is inserted into the skived end of the hose, and then the socket is reduced or “crimped” around the hose and body. The hose reinforcing layer is trapped between the interior surface of the socket and the reinforcement trapping surface of the body to inhibit movement of the reinforcing layer relative to the inner tube.

The hose fitting of the present invention is particularly useful with hoses that include a para-aramid reinforced, polymeric fluorocarbon inner tube to prevent movement of the para-aramid reinforcement relative to the fluorocarbon inner tube when assembled. Various additional aspects of this invention will become apparent to those skilled in the art from the following detailed description of the preferred embodiments, when read in light of the accompanying drawings.

### BRIEF DESCRIPTION OF THE DRAWINGS

FIG. 1 is a partial cross-sectional view of a hose assembly employing the fitting of the present invention, shown prior to connecting the fitting to a hose.

FIG. 2 is a partial cross-sectional view of a body employed in the fitting of FIG. 1.

FIG. 3 is a partial cross-sectional view of the body according to an alternate embodiment of the present invention.

FIG. 4 is a partial cross sectional view of a socket employed in the fitting of FIG. 1

FIG. 5 is a partial cross-sectional view of the hose assembly of FIG. 1, shown after connection of the fitting to the hose.

### DESCRIPTION OF THE PREFERRED EMBODIMENTS

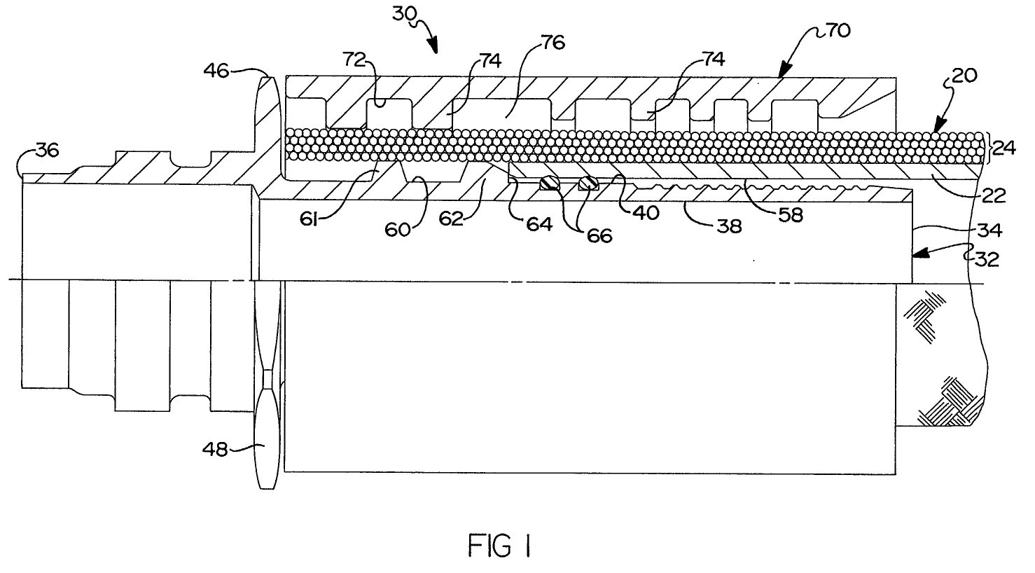

Referring now to the drawings, the preferred embodiments of the present invention are shown in detail. Referring to FIG. 1, there is shown a typical two-layer hose 20 that includes an inner tube 22 and an outer reinforcing layer 24 disposed about inner tube 22. Inner tube 22 is preferably made from a polymeric fluorocarbon material resistant to both chemical and heat degradation, thus allowing a variety of fluids, particularly fuels, fuel additives and hydraulic fluids, e.g., detergents, alcohols, etc., to pass through inner tube 22 without corroding or degrading inner tube 22. Although inner tube 22 can be made of any number of polymeric fluorocarbon materials, it is commonly made from a polymer of the following: polytetrafluoroethylene (PTFE), the homopolymer of tetrafluoroethylene sold under the trademark TEFLON by DuPont, perfluoronated ethylene-propylene (FEP), the copolymer of tetrafluoroethliene and hexafluoropropylene sold under the trademark TEFLON FEP and various other fluoropolymers. Outer reinforcement layer 24 is made from at least one end or strand of a textile material that is braided or spiral wound over inner tube 22, as is known in the art. Exemplary reinforcement materials include para-aramids, such as KEVLAR or NOMEX, which are also sold by DuPont.

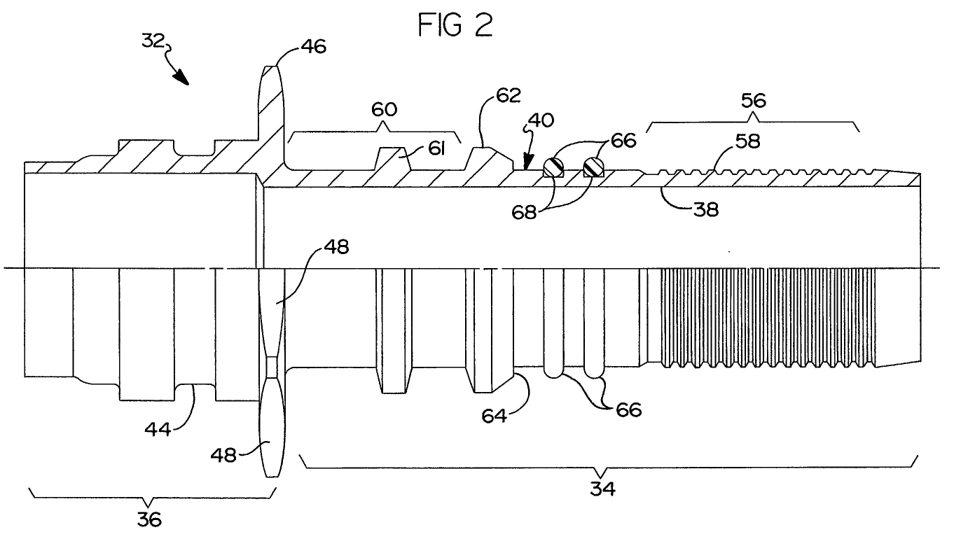

Referring to FIGS. 1 and 2, a hose fitting, according to the present invention, is generally indicated by the reference number 30. Normally, hose fitting 30 is constructed of metal; however, any suitable material having the requisite strength needed to sealingly engage hose 20 under high pressure, such as high strength plastics, are within the scope of this invention. Hose fitting 30 includes a longitudinally extending body 32 having a hose end 34 and a coupling end 36. Body 32 has a cylindrical interior opening 38 and an exterior surface 40.

In the embodiment illustrated in FIGS. 1 and 2, body 32 is configured to receive a coupling nut (not shown) that is rotatably mounted on coupling end 36 of body 32. Body 32 defines a groove 44 adjacent the coupling end 36. As is known in the art, the coupling nut includes a circular lip that is received in groove 44. The exterior surface 40 of body 32 also includes a raised portion 46, which defines a plurality of wrench flats 48 to assist in tightening the coupling nut when attaching hose fitting 30 to another member. It will be appreciated that the means of attaching hose fitting 30 to another member is not limited to use of a coupling nut, and that other attachment means may be used, including, but not limited to, the quick-connect coupling design disclosed in U.S. Pat. No. 5,553,895, which is owned by the assignee of the present invention and incorporated herein.

Exterior surface 40 of body 32 also defines a gripping surface 56. In the embodiment shown in FIG. 2, gripping surface 56 includes a plurality of angled shoulders or fins 58, which are engaged tightly with inner tube 22 of hose 20 after installation. However, it will be appreciated that gripping surface 56 may have various configurations and still fall within the scope of the present invention.

Exterior surface 40 of body 32 also defines a reinforcement trapping surface 60. Reinforcement trapping surface 60 may be substantially smooth, or may include at least one fin or projection 61 extending radially outward therefrom, as shown in FIGS. 1 and 2. Reinforcement trapping surface 60 and gripping surface 56 are preferably separated by an abutment 62 that extends radially outward from exterior surface 40 of body 32. Abutment 62 includes a rearward facing surface 64 that is substantially perpendicular to exterior surface 40. During assembly, inner tube 22 of hose 20 engages surface 64 to inhibit further axial movement of hose 20 onto body 32 and provides a tactile indication that body 32 is fully inserted into hose 20.

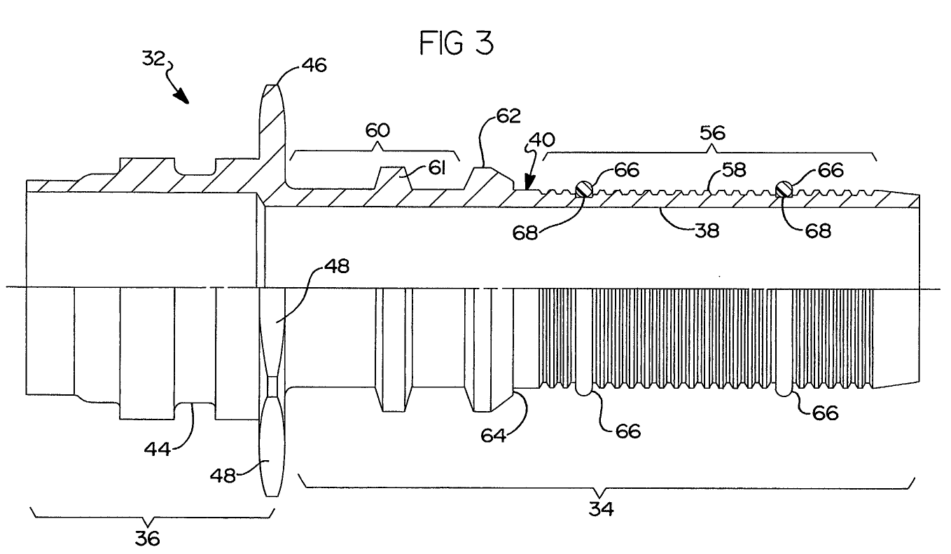

Optionally, at least one sealing member 66, such as an o-ring or other elastomeric seal, may be disposed in exterior surface 40 of body 32 to provide a seal between body 32 and inner tube 22 of hose 20. Sealing member 66 is received in an inwardly facing groove 68 in exterior surface 40. In the embodiment shown in FIGS. 1 and 2, two sealing members 66 are positioned between abutment 20 and gripping surface 56. Alternatively, one or more sealing members 66 may be positioned within gripping surface 56 when gripping surface 56 extends from hose end 34 to abutment 62, as shown in FIG. 3.

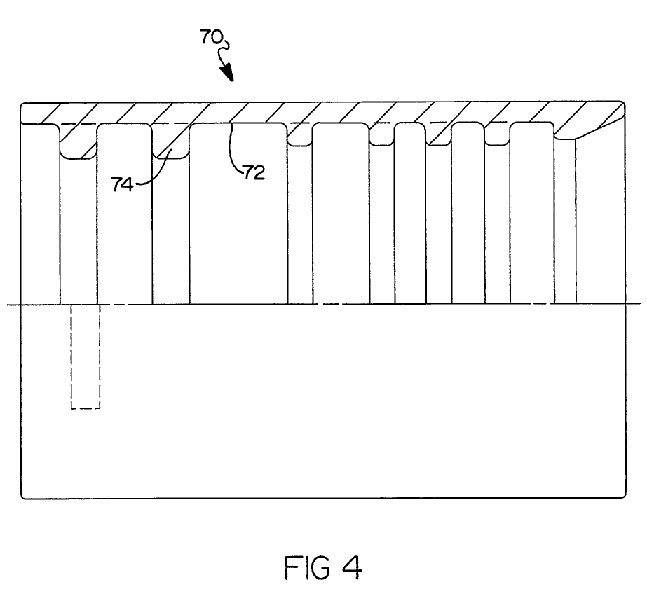

Referring to FIGS. 1 and 4, fitting 30 also includes a socket 70 that surrounds body 32. Socket 70 includes an interior surface 72 that defines at least one retaining feature, such as projection 74. In the embodiment illustrated in FIG. 4, each projection 74 is an annular rib that extends radially inward toward body 32. Alternatively, interior surface 72 may include, for example, a continuous helical thread or a plurality of serrations (none shown).

Referring again to FIG. 1, interior surface 72 of socket 70 and exterior surface 40 of body 32 define a generally cylindrical opening 76 for the receipt of hose 20. After assembly, interior surface 72 is positioned radially outward of gripping surface 56 and reinforcement trapping surface 60. As illustrated in FIG. 1, interior surface 72 may include two distinct regions of projections 74 that are positioned radially outwardly of gripping surface 56 and reinforcement trapping surface 60 after assembly.

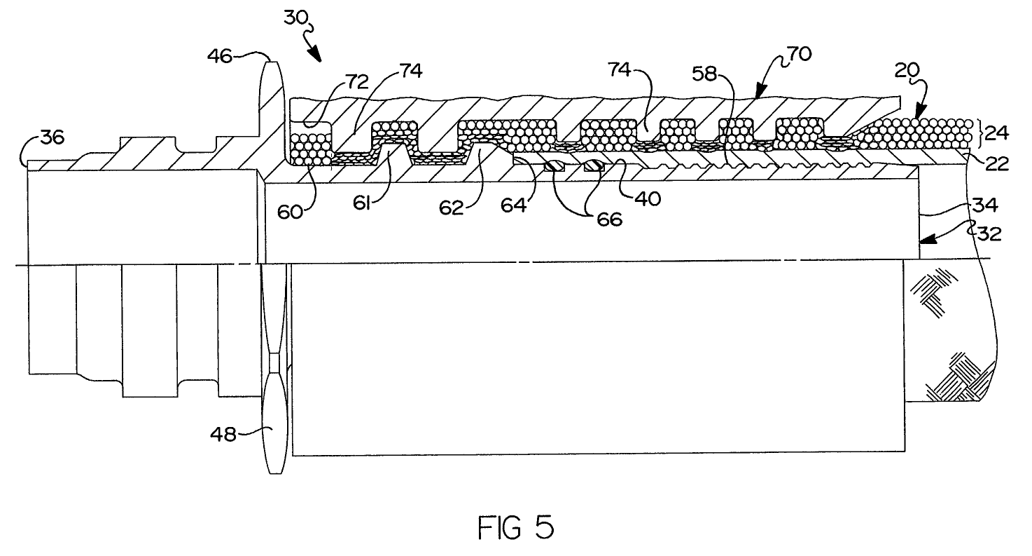

Assembly of fitting 30 onto hose 20 will now be described with reference to FIGS. 1 and 5. Prior to assembly, a portion of inner tube 22 is removed or “skived” from hose 20 using a skiving method well known in the art, such as a “hot wire” method. Body 32 is then inserted into socket 70 or socket 70 is slipped over the skived end of hose 20. Body 32 is then inserted into inner tube 22 of hose 20 until the skived end of inner tube 22 engages abutment 62. Fitting 30 and hose 20 are then inserted into a crimping apparatus, such as a crimping apparatus similar to that described in U.S. Pat. No. 5,720,197, which is owned by the assignee of the present invention and is incorporated by reference. The outer diameter of socket 70 is then “crimped” or reduced around hose 20 and body 32, thereby sandwiching hose 20 between gripping surface 56 of body 32 and interior surface 72 of socket 70. Socket 70 also sandwiches reinforcement 24 between reinforcement trapping surface 60 and interior surface 72. The compression of socket 70 against hose 20 causes inner tube 22 to seal against gripping surface 56 and sealing members 66. Additionally, the compression of socket 70 against reinforcement layer 24 in the area of reinforcement trapping surface 60 inhibits axial movement of reinforcement layer 24 relative to body 32 and inner tube 22 of hose 20. In this manner, the sealing performance of the hose assembly at the interface of hose 20 and fitting 30 is maintained.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications and variations will come within the teachings of this invention and that such variations and modifications are within its spirit and the scope as defined by the claims.

What is claimed is:

1. A hose fitting for use with a hose, comprising:
a longitudinally extending body having a hose end and a coupling end, the body having an exterior surface and an interior opening, the exterior surface defining a gripping surface and a reinforcement trapping surface; and
a socket surrounding the body, the socket including an interior surface positioned radially outward of the gripping surface and the reinforcement trapping surface, the interior surface of the socket and the exterior surface of the body defining an opening for receiving the hose.

2. The hose fitting of claim 1, wherein the hose includes an inner tube, the exterior surface of the body includes an abutment for engaging the inner tube.

3. The hose fitting of claim 2, wherein the abutment is positioned between the gripping surface and the reinforcement trapping surface.

4. The hose fitting of claim 1, wherein the interior surface of the socket includes at least one retaining feature.

5. The hose fitting of claim 4, wherein the retaining feature is a radially inwardly directed projection.

6. The hose fitting of claim 1, wherein the exterior surface of the body includes at least one radially inwardly directed groove for receiving a sealing member.

7. The hose fitting of claim 6, wherein the groove and the sealing member are positioned between the gripping surface and the reinforcement trapping surface.

8. The hose fitting of claim 7, wherein the groove and the sealing member are positioned within the gripping surface.

9. The hose fitting of claim 1, wherein the reinforcement trapping surface includes at least one radially outwardly directed projection.

10. A hose fitting for use with a hose, comprising:
a longitudinally extending body having a hose end and a coupling end, the body having an exterior surface and an interior opening, the exterior surface defining a gripping surface that includes a plurality of fins and a reinforcement trapping surface that includes at least one radially outwardly directed projection; and
a socket surrounding the body, the socket defining an interior surface, the interior surface of the socket and the exterior surface of the body defining a generally cylindrical opening for receiving the hose, the interior surface of the socket including a plurality of projections, at least one of the projections positioned radially outwardly of the gripping surface and the reinforcement trapping surface.

11. A hose assembly comprising:
a hose that includes a first layer and a second layer overlaying the first layer, the second layer extending a predetermined axial distance beyond the first layer; and
a hose fitting that includes a longitudinally extending body and a socket, the longitudinally extending body including an exterior surface and an interior opening, the exterior surface defining a first region and a second region, the socket surrounding the body and including an interior surface, the interior surface and the first region defining an opening for receiving the first and second hose layers and the interior surface and the second region defining an opening for receiving the portion of second layer that extends beyond first layer.

12. The hose assembly of claim 11, wherein an abutment is positioned between the first region and the second region.

13. The hose assembly of claim 11, wherein the interior surface of the socket includes at least one retaining feature.

14. The hose assembly of claim 13, wherein the retaining feature is at least one radially inwardly directed projection.

15. The hose assembly of claim 11, wherein the exterior surface of the body includes at least one radially inwardly directed groove for receiving a sealing member.

16. The hose assembly of claim 15, wherein the groove and the sealing member are positioned between the first region and the second region.

17. The hose assembly of claim 15, wherein the groove and the sealing member are positioned within the first region.

18. The hose assembly of claim 11, wherein the first region includes a plurality of fins.

19. The hose assembly of claim 11, wherein the second region includes at least one radially outwardly directed projection.
